(19) United States
(12) Patent Application Publication
(10) Pub. No.: US 2004/0162144 A1
(43) Pub. Date: Aug. 19, 2004

(54) Communication between players at gaming terminals

(76) Inventors: Timothy C. Loose, Chicago, IL (US); Wayne H. Rothschild, Northbrook, IL (US)

Correspondence Address: Michael L. White, WMS Gaming Inc., 3401 N. California Ave., Chicago, IL, 60618, US

(21) Appl. No.: 10/369,021

(22) Filed: Feb. 19, 2003

(51) Int. Cl. G06F 17/00

(52) U.S. Cl. 463/42

(57) ABSTRACT

A system and method for allowing players at gaming terminals to communicate with each other is disclosed. The gaming terminals are used to conduct wagering games. One of the gaming terminals generates a personal message in response to input of a player at the one of the gaming terminals. A least one other of the gaming terminals presents the personal message. The personal message may include text, audio, or video content and may be generated via such messaging technologies as electronic mail, instant messaging, a chat room, network telephony, conferencing, and an electronic message center.

### RELATED APPLICATION

This application is related to U.S. patent application Ser. No. 10/092072 (Attorney Docket No. 47079-00125) entitled “Integration of Casino Gaming and Non-casino Interactive Gaming”, which was filed on Mar. 6, 2002, and is assigned to the assignee of the present application, and is incorporated herein by reference in its entirety.

### FIELD OF THE INVENTION

The present invention relates generally to gaming terminals and, more particularly, to a system and method for allowing players at gaming terminals to communicate with each other.

### BACKGROUND OF THE INVENTION

Gambling is becoming an increasingly popular form of entertainment, offering players many gaming options including, for example, table games and electronic gaming terminals. Table games, such as craps, blackjack, and other card games, provide entertainment value in part because of the social atmosphere surrounding such games. Some table games encourage a team-like mentality where a group of players interact with each other for help or moral support and play against the casino (i.e., “house”). Other table games encourage a competitive mentality where a group of players interact with and compete against each other.

In stark contrast to table games, electronic gaming terminals such as reel slot machines, video poker machines, video bingo machines, and the like generally encourage isolation among players. Because such terminals are an important source of income for the gaming industry, casinos continually search for new gaming strategies and features to distinguish their electronic gaming terminals from competitors in the industry and to provide additional incentives for players to play longer and to return to the casino on their next trip. For example, gaming terminals have been linked to a system controller for such purposes as player tracking, cashless gaming, tournaments, and bonusing (e.g., progressives, mystery jackpots, multiple jackpots, etc.). In the above circumstances, the gaming terminals primarily communicate with the system controller and not with each other so that players still remain isolated from each other and do not interact with each other as in table games. Many potential players are averse to the isolation involved in the play of electronic gaming terminals.

In an effort to increase the entertainment experience and the level of social interaction among players of electronic gaming terminals, gaming terminals have been linked to play a common game, such as roulette, bingo, racing, or other type of multi-player game, presented on a large display. Also, gaming terminals have been linked to a large display positioned above the terminals and used to present a special feature triggered by one of the terminals. The presentation of a common game or special feature on the large display helps to promote a festive atmosphere and a shared experience among players and bystanders in proximity to the display. Nonetheless, there is a continuing need for gaming terminal manufacturers to provide new techniques for enhancing the level of social interaction involved in the play of electronic gaming terminals.

### SUMMARY OF THE INVENTION

In accordance with the present invention, a system and method for allowing players at gaming terminals to communicate with other, or to allow a player at a gaming terminal to communicate with an individual at a remote location, using a multimedia messaging system (MMS) is disclosed. The gaming terminals are used to conduct wagering games. One of the MMS capable gaming terminals generates a personal message in response to input of a player at the one of the gaming terminals. A least one other of the MMS capable gaming terminals presents the message. The message may include text, audio, or video content and may be generated via such messaging technologies as electronic mail, instant messaging, a chat room, network telephony, conferencing, and an electronic message center. The personal message may also be sent to a remote location outside the gaming establishment to a remote terminal (e.g., a personal computer).

### BRIEF DESCRIPTION OF THE DRAWINGS

The foregoing and other advantages of the invention will become apparent upon reading the following detailed description and upon reference to the drawings.

FIG. 1 is a local area network utilizing a bus topology communication structure.

FIG. 2 is a local area network utilizing a star topology communication structure.

FIG. 3 is a local area network utilizing a ring topology communication structure.

FIG. 4 is a local area network utilizing a tree (also known as a hybrid) topology communication structure.

FIG. 5 is a local area network utilizing a mesh topology communication structure.

FIG. 6 is a central system for linking a network of MMS capable gaming terminals.

FIG. 7 is a gaming terminal with communication capability through a communication network.

FIG. 8 is a functional block schematic of the gaming terminal shown in FIG. 7.

FIG. 9 is a functional block schematic of the communication module of FIG. 8.

FIG. 10 is a typical gaming terminal video screen display for accessing the communication network.

FIG. 11 is a typical welcome screen that allows users to select a communication mode.

FIG. 12 is a typical e-mail welcome screen that allows users to either read or write messages.

FIG. 13 is a typical e-mail screen display that allows players to address a message to another player.

FIG. 14 is a global e-mail address list for all participating players with permanent or temporary identifiers.

FIG. 15 is a typical e-mail screen display listing a player's new messages.

FIG. 16 is a typical e-mail screen display of a message as it is displayed for player inspection.

FIG. 17 is a typical screen display for accessing a communication channel to a specific gaming terminal based on its location.

FIG. 18 is a typical screen display for accessing a communication channel to a specific gaming terminal based on a randomly assigned player identifier.

FIG. 19 is a typical screen display for accessing a communication channel to a specific gaming terminal based on the gaming terminal's identifier.

FIG. 20 is a typical screen display for accessing a communication channel to instant message a specific player.

FIG. 21 is a typical screen display for a chat room welcome screen that allows players to select a chat room to enter.

FIG. 22 is a typical chat room screen display that allows players to read or write messages to a group of players entered in a chat room.

FIG. 23 is a typical screen display for a bulletin board welcome screen that allows players to select a bulletin board.

FIG. 24 is a bulletin board screen display that allows players to read posted messages and to post new messages to the board.

FIG. 25 is a voice communication screen display that allows a player to select and establish an audio connection with another player.

FIG. 26 is a voice communication screen display that shows the audio communication status as well as allowing the connection and disconnection of players from the communication.

FIG. 27 is a typical video conferencing screen display that allows players to select a player with whom they wish to videoconference.

FIG. 28 is a video conferencing screen display that shows the video conferencing status as well as allowing the connection and disconnection of players from the communication.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

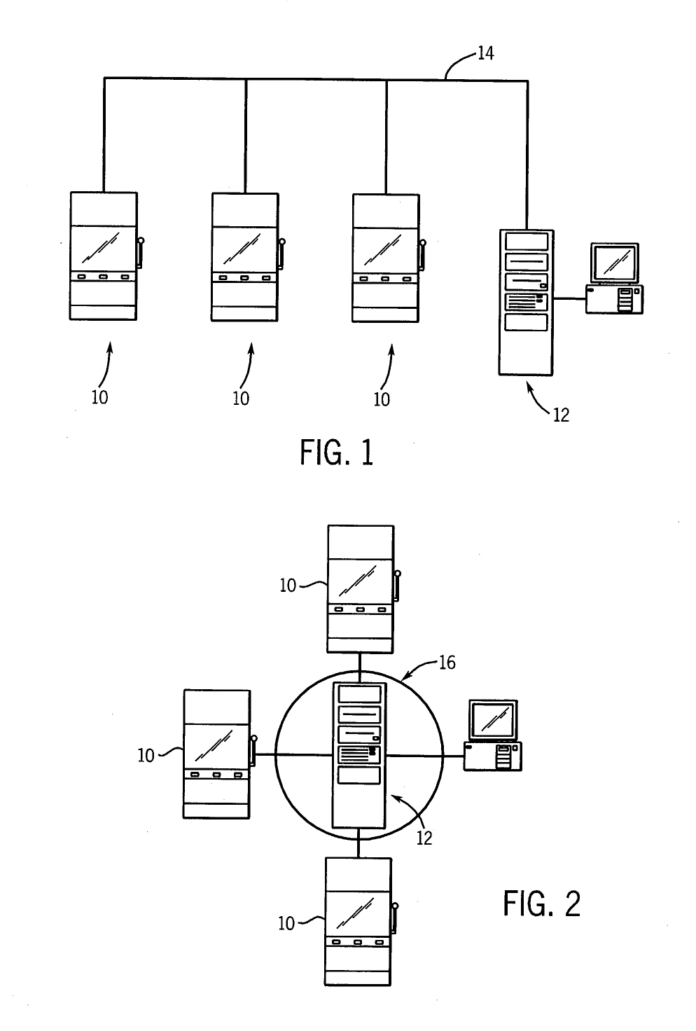

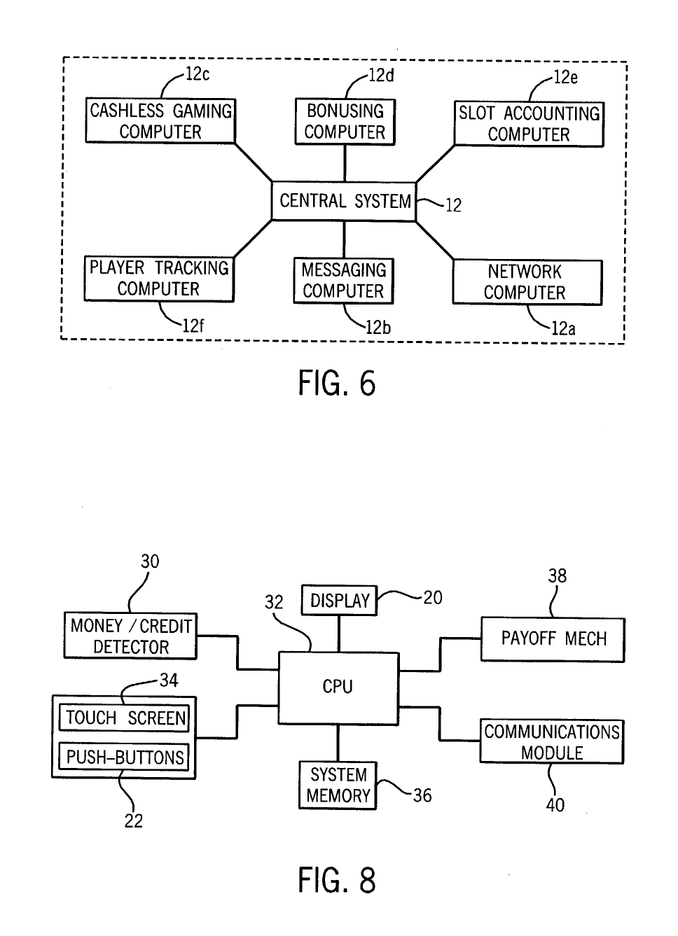

Turning now to the drawings, FIG. 1 depicts a system for allowing players at gaming terminals 10 to communicate with each other. In the illustrated embodiment, the terminals 10 are linked to a central system 12 over a distributed network. The central system 12 manages network resources (e.g., files, storage, application programs, printers, and other devices) and may, for example, include a network computer 12a for managing network traffic, a messaging computer 12b, a cashless gaming computer 12c, a bonusing computer 12d, a slot accounting computer 12e, and a player tracking computer 12f as depicted in FIG. 6. These so-called “computers”may be physically separated into distinct hardware components that are linked over the network, or may be physically combined into one or more hardware components and only logically separated from each other.

The multimedia messaging system (MMS) utilizes a messaging computer 12b manages the transmission of messages over the distributed network. The messaging computer 12b brings messaging capabilities to the MMS capable gaming terminals 10 by awaiting and fulfilling requests from the terminals 10 to deliver messages to other terminals 10 and/or post messages on the messaging computer 12b. Each of the terminals 10 is associated with a unique address that allows any computer in the central system 12 to identify the individual terminals 10. Messages may be delivered from one terminal 10 to one or more other terminals 10 either via the messaging computer 12b or directly without passing through the computer 12b.

The cashless gaming computer 12c manages and validates electronic funds transactions. For example, the cashless gaming computer 12c may store funds in monetary accounts at the computer, authorize the transfer of funds between the accounts and the gaming terminals 10, and associate the accounts with portable instruments such as cards or tickets used by players at the gaming terminals 10.

The bonusing computer 12d manages a variety of promotional bonuses such as multiple jackpot bonuses, mystery jackpot bonuses, progressive jackpot bonuses, or player specific bonuses. The bonusing computer 12d may allow the casino to select which of the gaming terminals 10 are used in any given promotional bonus and may allow any number of different promotional bonuses to operate simultaneously.

The slot accounting computer 12e monitors the usage and payout of the individual gaming terminals 10 by collecting such audit data as credits in, credits out, credits played, credits won, titles of games played, terminals played, denominations of games played, number of games played, duration of play, and specific times of play. Of course, the amount and types of collected audit data may be varied to suit a particular casino. The slot accounting computer 12e may compile an accounting report based on the audit data from each of the individual gaming terminals 10, and the report may, in turn, be used by management to assess the performance and profitability of the terminals 10.

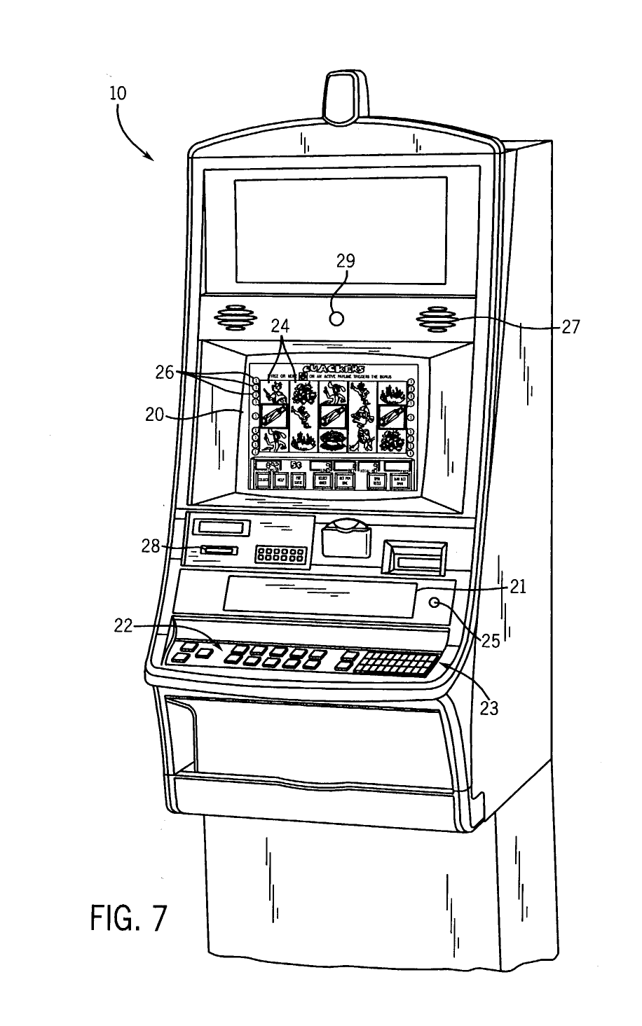

The player tracking computer 12f tracks individual player usage of the gaming terminals 10. When a player enrolls in a casino's player tracking system, often called a “slot club” or a “rewards program,” the casino issues a player identification card that has encoded thereon a player identification number that uniquely identifies the player. The identification card may, for example, be a magnetic card or a smart (chip) card. Each terminal 10 is fitted with a card reader (e.g., card reader 28 in FIG. 7) into which the player inserts his or her identification card prior to playing the associated terminal 10. The card reader reads the player identification number off the card and informs the player tracking computer 12f connected thereto of the player's subsequent gaming activity. By tracking the individual players, individual player usage can be monitored by associating certain of the audit data with the player identification numbers. This allows gaming establishments to target individual players with direct marketing techniques, comps, and other rewards according to the individual's usage.

Instead of issuing a player identification card to a player when the player joins a casino's player tracking system, the casino may acquire a reference biometric attribute such as a fingerprint for uniquely identifying the player. Each gaming terminal 10 is fitted with a biometric reader into which the player inserts his or her finger prior to playing the associated terminal 10. The biometric reader reads the fingerprint from the finger and transmits the live fingerprint data to the player tracking computer 12f. If the player tracking computer 12f determines that the live fingerprint data sufficiently matches the reference fingerprint data stored at the player tracking computer 12f, the terminal 10 informs the player tracking computer 12f of the player's subsequent gaming activity.

In addition to the above-noted computers, the system may include one or more proxy servers for improving network performance. The proxy server(s) would sit between the terminals 10 and the computers at the central system 12. A proxy server intercepts all requests to the computers at the central system 12 to see if it can fulfill the requests itself. If not, the proxy server forwards the request to the central system 12.

The distributed network may be a wired network as shown or a wireless network, and, depending upon the type and amount of data to be transmitted, may utilize broadband or baseband transmission. The gaming terminals 10 may be geographically close together (e.g., in the same gaming establishment) so that the network is entirely a local-area network (LAN), or may be located in multiple gaming establishments so that the network is a wide-area network (WAN) that connects the LANs by telephone lines, radio waves, or other communications arrangement. The network may utilize one or more LAN topologies, protocols, and architectures.

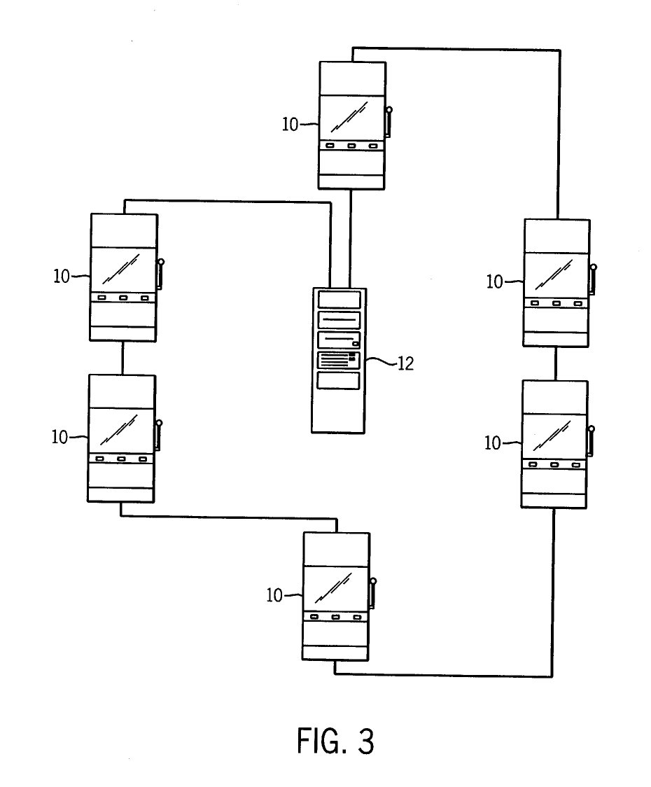

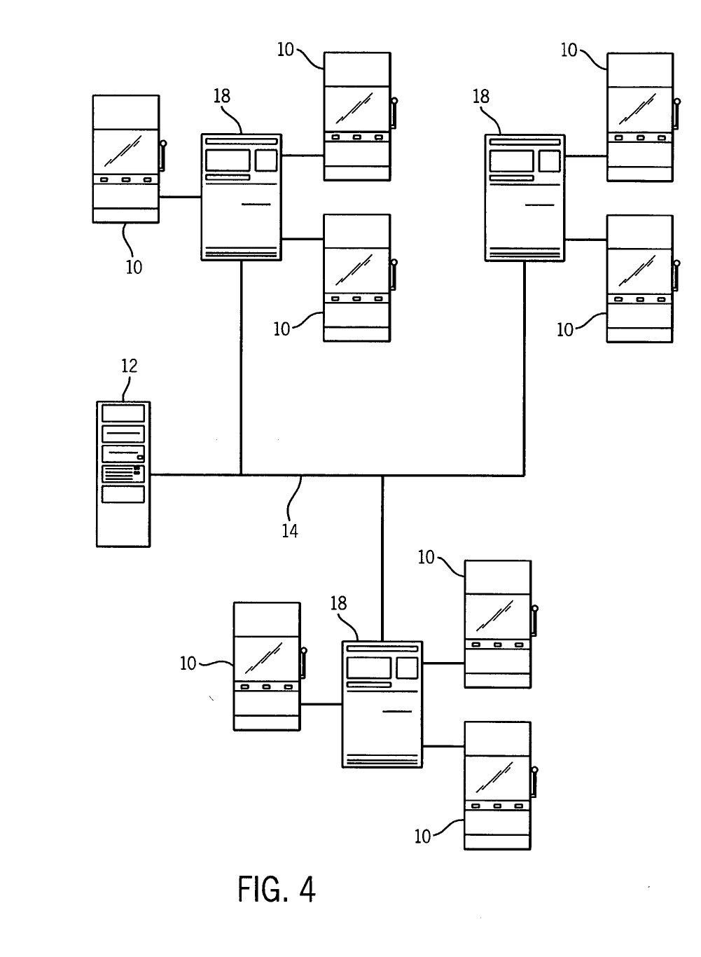

The LAN topology may be a bus topology, a star topology, a ring topology, a tree topology, or a mesh topology. FIG. 1 depicts a bus topology in which all terminals 10 and the central system 12 are connected to a central cable, called the bus or backbone 14. Bus networks are relatively inexpensive and easy to install for small networks. FIG. 2 depicts a star topology in which all terminals 10 are connected to a central hub 16. The central system 12 may reside at the hub 16. The terminals 10 communicate across the network by passing data through the hub 16. Star networks are relatively easy to install and manage, but bottlenecks can occur because all data must pass through the hub 16. Ethernet systems generally use a bus or star topology. FIG. 3 depicts a ring topology in which all terminals 10 are connected to one another in the shape of a closed loop, so that each terminal 10 is connected directly to two other terminals 10, one on either side of it. Ring networks are relatively inexpensive and difficult to install, but they offer high bandwidth and can span large distances. FIG. 4 depicts a tree (or hybrid) topology that combines characteristics of linear bus and star topologies. It consists of groups of star-configured networks are connected to a linear bus backbone 14. Each star-configured network may, for example, correspond to a bank or carousel of terminals 10 linked to a carousel controller 18. The above-noted topologies can also be mixed. For example, a bus-star network consists of a high-bandwidth bus that connects collections of lower-bandwidth star segments.

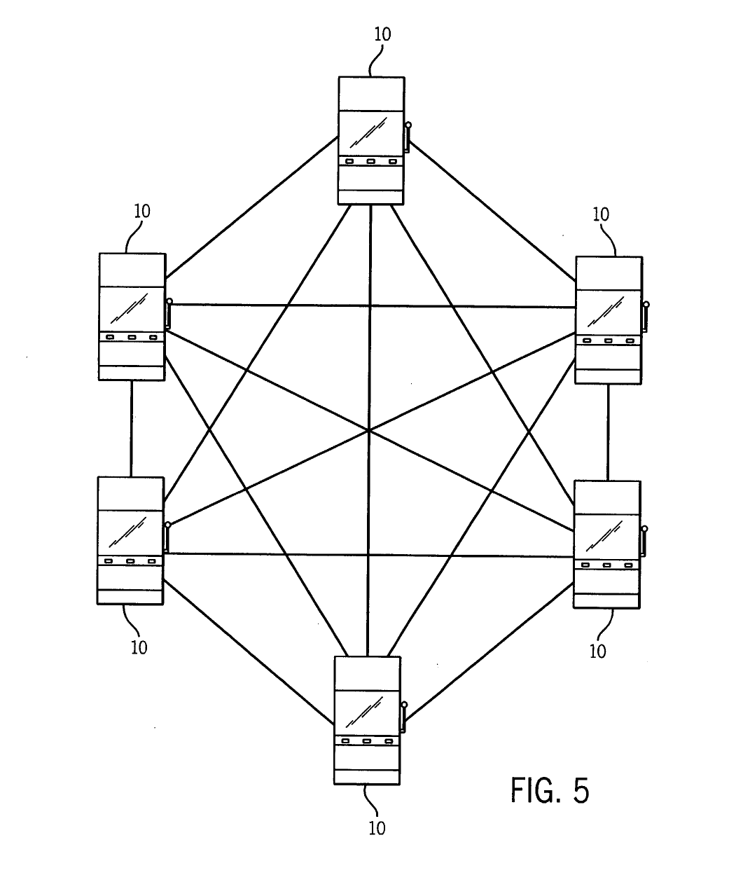

FIG. 5 depicts a mesh topology in which terminals 10 are connected with many redundant interconnections between them. There are two types of mesh topologies: full mesh and partial mesh. A full mesh topology occurs when every terminal 10 has a circuit connecting it to every other terminal 10 in the network. Full mesh is very expensive to implement but yields the greatest amount of redundancy, so in the event that one of the terminals 10 fails, network traffic can be directed to any of the other terminals 10. A partial mesh topology is less expensive to implement and yields less redundancy than a full mesh topology. With partial mesh, some terminals 10 are organized in a full mesh scheme but others are only connected to one or two terminals 10 in the network.

The architecture may, for example, be a client/server (two-tier) architecture. The computers and processes at the central system 12 are servers. The terminals 10 are clients that rely on the servers for resources, such as files, devices, and even processing power. Alternatively, the architecture may be a peer-to-peer architecture in which the terminals 10 and the computers and processes at the central system 12 have equivalent capabilities and responsibilities. Whether the architecture is client/server or peer-to-peer, the architecture may be either open or closed. An open architecture uses off-the-shelf components and conforms to approved standards, thereby allowing the system to be connected easily to devices and programs made by other manufacturers. A closed architecture uses a proprietary design, making it more difficult to connect the system to devices and programs made by other manufacturers.

The distributed network may be a virtual private network (VPN) that is constructed by using public wires to connect the gaming terminals 10. The VPN may rely upon proprietary or non-proprietary communications protocols for transmitting data over the network. By using a non-proprietary protocol such as TCP/IP (Transmission Control Protocol/Internet Protocol), the VPN may serve as a secured intranet accessible only by the gaming terminals or others with authorization. A firewall surrounding the intranet fends off unauthorized access. Secure intranets are a growing segment of the Internet because they are much less expensive to build and manage than private networks based on proprietary protocols.

FIG. 7 is an enlarged view of one of the gaming terminals 10. The terminal 10 is operable to conduct a wagering game such as slots, poker, keno, bingo, or blackjack. Generally, the terminal 10 receives a wager from a player to purchase a play of the game. In response, the terminal 10 generates at least one random event using a random number generator (RNG) and provides an award to the player for a winning outcome of the random event. Alternatively, the central system 12 (see FIG. 6) may generate the random event and transmit the event's outcome to the gaming terminal 10. To portray the outcome to the player, the terminal 10 includes a video display 20 as shown or a mechanical display. The video display 20 may be implemented with a CRT, LCD, plasma, or other type of video display known in the art. A secondary video display 21 may also be implemented to allow the communication activity to be separated from game play. To allow the player to place wagers, make game selections, and otherwise operate the terminal 10, the terminal 10 includes a touch screen over the video display 20 and/or a button panel 22 including a plurality of physical push buttons. The terminal 10 includes a card reader 28 for receiving a player identification card associated with the player tracking computer 12f.

Operation of the terminal 10 is described in greater detail below in the context of a video slot game. The video slot game is implemented on the video display 20 on a number of video simulated spinning reels 24 with a number of pay lines 26. Each of the pay lines 26 extends through one symbol on each of the reels 24. Generally, game play is initiated by inserting money or playing a number of credits, causing the terminal's CPU to activate a number of pay lines 26 corresponding to the amount of money or number of credits played. In one embodiment, the player selects the number of pay lines 26 to play by pressing a “Select Lines” touch key on the display 20. The player then chooses the number of coins or credits to bet on the selected pay lines 26 by pressing a “Bet Per Line” touch key.

After activation of the pay lines 26, the reels 24 may be set in motion by pressing a “Spin Reels” touch key or, if the player wishes to bet the maximum amount per line, by using a “Max Bet Spin” touch key on the display 20. Alternatively, other mechanisms such as a lever or push button may be used to set the reels in motion. The CPU uses a random number generator to select a game outcome (e.g., “basic” game outcome) corresponding to a particular set of reel “stop positions.” The CPU then causes each of the video reels 24 to stop at the appropriate stop position. Video symbols are displayed on the reels 24 to graphically illustrate the reel stop positions and indicate whether the stop positions of the reels represent a winning game outcome.

Winning basic game outcomes (e.g., symbol combinations resulting in payment of coins or credits) are identifiable to the player by a pay table. In one embodiment, the pay table is affixed to the terminal 10 and/or displayed by the display 20 in response to a command by the player (e.g., by pressing a “Pay Table” touch key). A winning basic game outcome occurs when the symbols appearing on the reels 24 along an active pay line correspond to one of the winning combinations on the pay table. A winning combination, for example, could be three or more matching symbols along an active pay line, where the award is greater as the number of matching symbols along the active pay line increases. If the displayed symbols stop in a winning combination, the game credits the player an amount corresponding to the award in the pay table for that combination multiplied by the amount of credits bet on the winning pay line. The player may collect the amount of accumulated credits by pressing a “Collect” touch key. In one implementation, the winning combinations start from the leftmost reel (left to right) and span adjacent reels. In an alternative implementation, the winning combinations start from either the leftmost reel (left to right) or the rightmost reel (right to left) and span adjacent reels.

Included among the plurality of basic game outcomes may be one or more start-feature outcomes for triggering play of special features. A start-feature outcome may be defined in any number of ways. For example, a start-feature outcome may occur when a special start-feature symbol or a special combination of symbols appears on one or more of the reels 24. The start-feature outcome may require the combination of symbols to appear along an active pay line, or may alternatively require that the combination of symbols appear anywhere on the display 20 regardless of whether the symbols are along an active pay line. The appearance of a start-feature outcome causes the CPU to shift operation from the video slot game to the special feature associated with that outcome. Implementations of special features are described in U.S. Pat. No. 6,190,255 B1, which is incorporated herein by reference in its entirety.

FIG. 8 is a block diagram of a control system suitable for operating the gaming terminal. Money/credit detector 30 signals a central processing unit (CPU) 32 when a player has inserted money or played a number of credits. The money may be provided by coins, bills, tickets, coupons, cards, etc. Using the button panel 22 (see FIG. 7) or a touch screen 34, the player may select any variables associated with the wagering game (e.g., number of pay lines in a video slot game) and place his/her wager to purchase a play of the game. In a play of the game, the CPU 32 generates at least one random event using a random number generator (RNG) and provides an award to the player for a winning outcome of the random event. The CPU 32 operates the display 20 to represent the random event(s) and outcome(s) in a visual form that can be understood by the player. In addition to the CPU 32, the control system may include one or more additional slave control units for operating additional video and/or mechanical displays.

A system memory 36 stores control software, operational instructions and data associated with the gaming terminal. In one embodiment, the system memory 36 comprises a separate read-only memory (ROM) and battery-backed random-access memory (RAM). However, it will be appreciated that the system memory 36 may be implemented on any of several alternative types of memory structures or may be implemented on a single memory structure. A payoff mechanism 38 is operable in response to instructions from the CPU 32 to award a payoff to the player. The payoff may, for example, be in the form of a number of credits. The number of credits is determined by one or more math tables stored in the system memory 36.

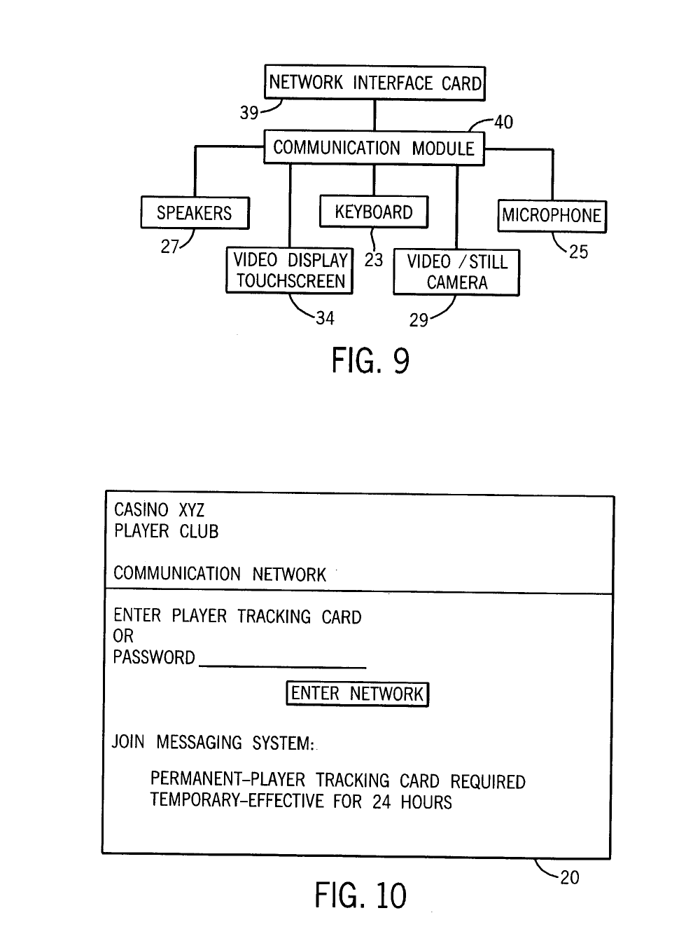

The gaming terminal also contains hardware that enables a variety of different types of communication methodologies. For voice communication the gaming terminal is shown in FIG. 7 with speakers 27 and a microphone 25. For video conferencing a video camera 29 is also provided. For e-mail, instant messaging, and chat room discussions a keyboard 23 is provided. Finally, if desired, a secondary video display 21 may be provided in the gaming terminal. This secondary video display 21 may be used to communicate with players while allowing the player to continue game play on the primary video display 20. All of these devices may be linked to the communications module 40 shown in FIG. 8 and FIG. 9.

The communications module 40 enables the terminal 10 to communicate with other terminals 10 and the central system 12 over a network as shown in FIG. 8. The communications module 40 may include a network interface card (NIC) for connecting the terminal 10 to the LAN and communications software for sending and receiving data over the network (see FIG. 9). Alternatively, the communications module 40 may include a modem. A combination of different types of communications modules may be used where several different types of gaming terminals 10 are to be linked together. In addition to allowing communication between gaming terminals, it is also possible for the central system 12 to act as a server and connection to a global computing network (e.g., the Internet). In this configuration messages may not only be sent over the LAN to other gaming terminals, but also to any remote terminal (e.g., a personal computer) any where in the world that the internet reaches.

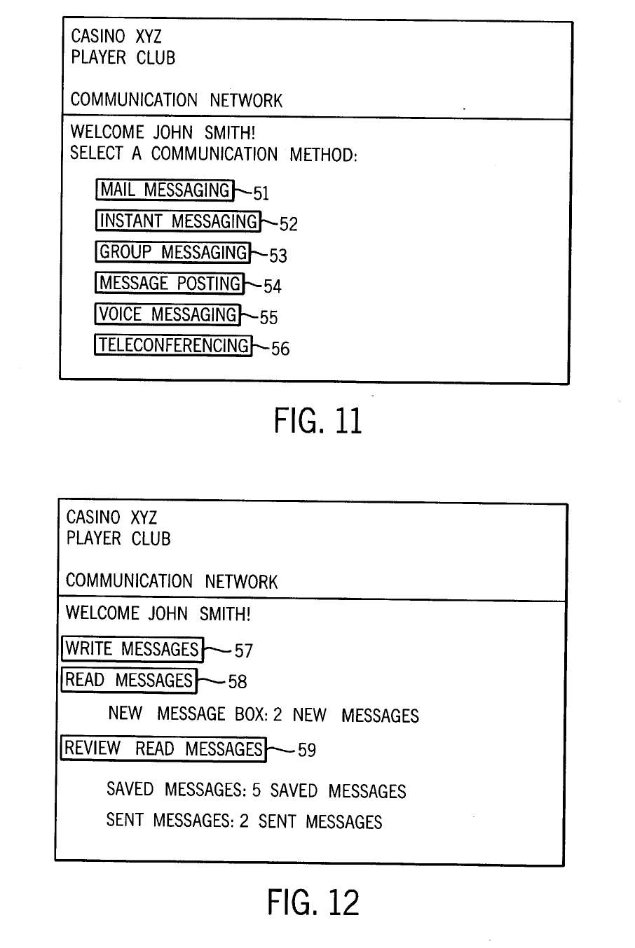

Referring back to FIGS. 1-5 and FIG. 6, with the assistance of the messaging computer 12b, the network allows players at the gaming terminals 10 to communicate with each other. Personal messaging can take various forms, including for example electronic mail (e-mail), instant messaging, text messaging, chat rooms, network telephony (voice over network), conferencing (audio or video), and message centers (e.g., bulletin boards, forums/newgroups, discussion groups, and online services). These communications methodologies may be presented to a player on the video display 20 for the player's selection as shown in FIG. 11. FIG. 11 depicts a typical display screen that allows a player to elect the communication mode that is desired. For-example, the player may select electronic mail messaging 51, instant messaging 52, group messaging 53, message posting 54, voice messaging 55, and teleconferencing 56. The terminals 10 include any special hardware and software required to enable the foregoing types of personal messaging as discussed above.

Access to these communication methodologies may be limited to players with some type of identification card, e.g., a player tracking cards. Alternately, casinos may provide players without such an identification card temporary access to the system using a password system for security. FIG. 10 depicts an opening screen for access to the communications capabilities of the network. A player may utilize either a player tracking card or a temporary password to gain access to the network.

E-mail is one of the most predominant and important modes of communication. Players at the gaming terminals 10 may access the networks to communicate with each other via e-mail. E-mail involves the transmission of messages over the distributed network. Each gaming terminal 10 executes an e-mail client that enables the terminal 10 to send, receive, edit, and organize e-mail. Mail is sent from the terminals 10 to the messaging computer 12b, which re-routes the mail to its intended destination. Messages entered from an alphanumeric keyboard 23, predefined messages in a menu from which a player makes a selection, or electronic files stored on the messaging computer 12b or the player's identification card. The alphanumeric keyboard 23 may be part of the terminal's button panel 22 or touch screen video display 34. The e-mail system may be confined to a network such as illustrated in FIGS. 1-5, or may support a gateway to other computer systems to enable players to exchange e-mail with users of such other systems.

Personal messages may be created by players from scratch and/or selected by players from a menu of predefined (“canned”) messages. A gaming terminal 10 may be outfitted with different types of tools for creating different types of messages from scratch. If a message includes text, the text may be typed by a player with either a physical keyboard 23 on the button panel 22 or an onscreen keyboard shown on the touch screen video display 20 (see FIG. 7). If a message includes a player's voice, the gaming terminal 10 may include a microphone 25 for capturing the player's voice. If a message includes a player's image, the gaming terminal 10 may include a video camera 29 for capturing the player's image. If the personal messages are selected by players from a menu of predefined messages, the video display 20 may depict the menu of predefined messages. The player selects one of the messages from the menu by touching the desired message.

The e-mail system includes a text editor for composing and editing messages. A player can then send the composed e-mail to a recipient, e.g., another player, by specifying the recipient's e-mail address. The player can also multicast the same message to several recipients at once. An example of multicasting is sending an e-mail message to a mailing list, i.e., a list of e-mail addresses identified by a single name. When an e-mail message is sent to the mailing list name, it is automatically forwarded to all the addresses in the list. The messaging computer 12b may include a mailing list server that manages centralized mailing lists for groups of users.

Sent messages are stored in electronic mailboxes until the recipient requests them. In order for a player to see if the he or she has any e-mail, the player may have to check the player's electronic mailbox periodically, although the e-mail system may also alert the player when e-mail is received. After reading any received e-mail, the player can store it in a text file (e.g., on the messaging computer 12b or the player's identification card), forward it to other players, or delete it. Messages can be printed out on a printer at the gaming terminal 10 if the player wants a paper copy.

In addition to text messages, the e-mail system may support audio, i.e., voice mail. Players can leave spoken messages for one another and listen to messages by executing the appropriate command in the e-mail system.

When a player enrolls in the player tracking system, the player is preferably given the option to register for a private mailbox to be associated with the player's identification card. If a player does not register for a private mailbox when the player is first issued an identification card, the player may later be given the option to register for a private mailbox when the player uses the identification card at a gaming terminal 10. The private mailbox is an area in memory or on a storage device where e-mail is placed. The memory or storage device may be located at the central system 12 in the messaging computer 12b (or the player tracking computer 12f). When a player receives e-mail, the e-mail system automatically puts it in the mailbox. The e-mail system allows a player to scan mail that is in his or her mailbox, copy it to a file (e.g., on the messaging computer 12b or the player's identification card), delete it, print it (e.g., on a printer at the gaming terminal 10), or forward it to another player. Each private mailbox is identified by a unique e-mail address, such as <myname>@<casinoname>.com (e.g., johnsmith@xyzcasino.com). Because of security concerns, and a desire to maintain and preserve the anonymity of the casino's players, rather than utilizing the player's actual name, the player may select a pseudonym for their e-mail address.

If a player registers for a private mailbox, the player may be given the option at registration to receive opt-in e-mail. Opt-in e-mail refers to promotional e-mails that have been requested by the player receiving them. Opt-in e-mails are targeted and often personalized and carry information about specific topics or promotions that players are interested in learning about. Typical opt-in e-mails contain newsletters, product information, or special promotional offers. For example, if a player frequents gaming terminals 10 that offer video poker, the player could “opt in” to receive announcements relating to video poker. The promotional e-mail may even present the recipient with a special promotional offer to purchase poker products at a casino store at a discount available only to those on the opt-in list.

The casino may also disseminate unsolicited e-mail to all players who register for private mailboxes. Alternatively, to minimize player annoyance caused by unsolicited materials, the casino may selectively disseminate such e-mail. Criteria may be established for sending unsolicited e-mail to players based on a certain threshold of correlation between the subject matter of the e-mail and information concerning the player's interests, preferences, and/or terminal usage. A player may provide information concerning the player's interests and preferences when registering for a private mailbox. As noted previously, the player tracking computer 12f tracks individual player usage of the gaming terminals 10 as the player plays the terminals 10. For example, the criteria for sending an unsolicited e-mail related to video poker to a player may be that the player has played video poker at least once in the last month and, when registering for a private mailbox, indicated that the player's favorite electronic wagering game is video poker.

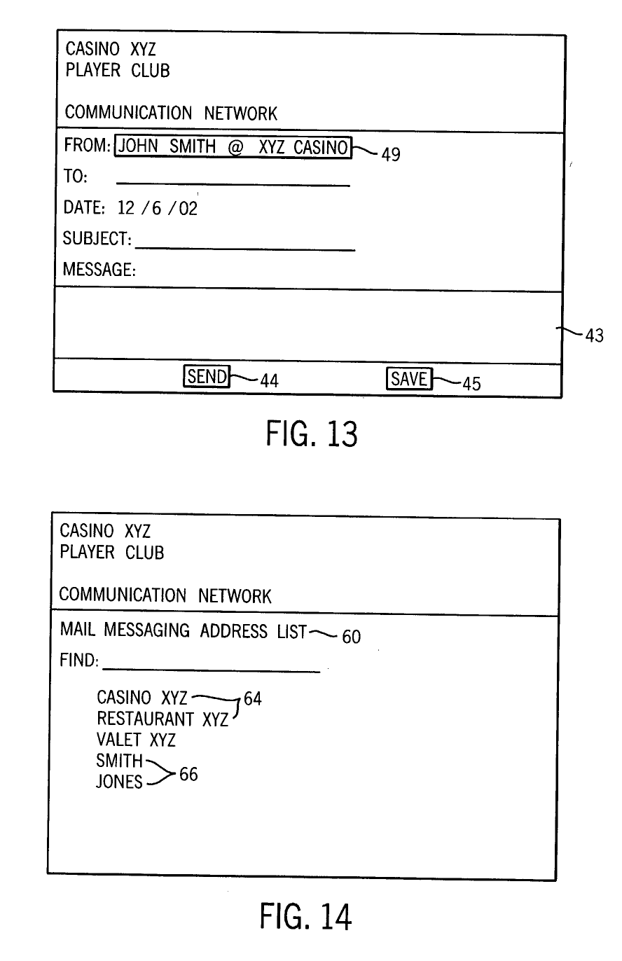

The e-mail messaging system has many different use modes depending on the information available to the sender. FIG. 12 depicts the opening screen for E-mail communication. The user may either select to write messages 57, read messages 58, or review read messages 59. To write a message the write message icon is activated and a blank message form as depicted in FIG. 13 is produced on the display screen. For example, to contact a specific player with a known address, the sender need only enter that player's address as the electronic mail receiver 41. If the player's e-mail address is unknown, an individual may scan an address list 60 such as depicted in FIG. 14 to attempt to identify the recipient.

A player, who is logged into the network with their player tracking card, or other identification card, or who have been assigned a temporary e-mail address, will automatically have their e-mail address entered as the electronic mail sender 49. The sender may then type the message he wants delivered into the message box 43. The subject of the message may be entered as the electronic mail subject 42. Date and time of the message is automatically recorded and displayed on the e-mail message. Any errors in the e-mail may be edited with the text editor. The player then sends the message to the e-mail recipient by activating the send message icon 44. Alternately the player may decide to save the message for further editing and may do so by activating the save message icon 45.

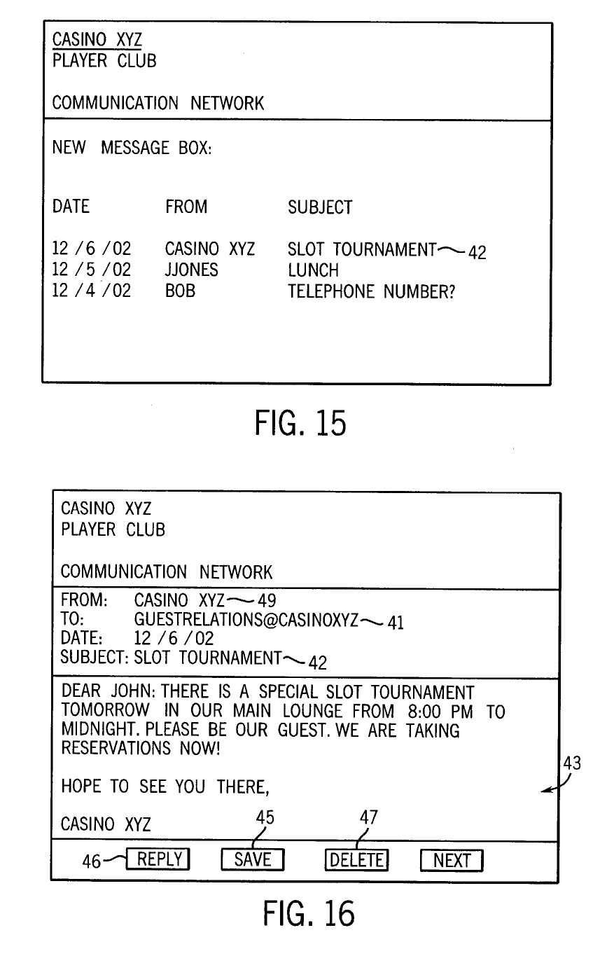

The central system may then use the player tracking computer 12f to determine the e-mail recipient's location on a specific gaming terminal (assuming the player is logged into the gaming terminal with a player-tracking card). The message may then be delivered immediately by routing the message directly to the specified gaming terminal. If the intended recipient is not logged onto the network, the central system stores the message in the central system's memory as discussed above. When the intended recipient of the message does log onto the network through a gaming terminal, the stored message, and any others, are immediately presented to the player at the gaming terminal for retrieval as shown in FIG. 15. The player may then select the e-mails he wishes to view.

The player's e-mail file will typically show the senders e-mail address, the date and time the e-mail was sent, and a subject line as shown in FIG. 15. The recipient selects the e-mail he wishes to review and the message appears on the video display as shown in FIG. 16. The recipient may reply to the message by activating the message reply icon 46 and typing in a response as an electronic mail message 43. When the recipient has finished their reply, they activate the send message icon 44 (see FIG. 13), and the message is routed back to the sender in the same manner it was originally sent to the recipient.

An example of this process is shown in FIG. 16 where a player, John Smith, has been sent a message from guest relations inviting smith to join a tournament. The sender, in this case the casino's guest relations department, merely types in the recipient's address, along with a text message, and when satisfied with the content, authorizes the message to be sent. If the recipient Smith is playing on a gaming terminal he will receive notification that he has received a new message. If Smith is not currently logged onto a gaming terminal with a player-tracking card, or a temporary player password, the message will be stored in the central system until Smith logs onto the network. At that time Smith will receive the message shown in FIG. 16.

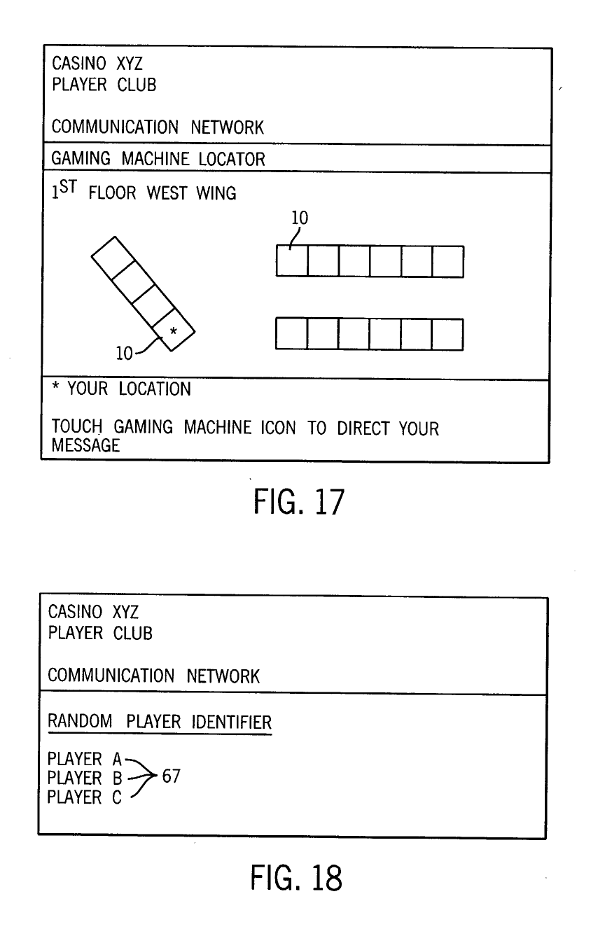

In another embodiment, the sender of the message may only know the recipients location on a specific gaming machine. A map of gaming terminal locations in the casino may be presented to the player as shown in FIG. 17. The sender's gaming terminal position may be displayed relative to all the other gaming terminals so that the sender may determine the position of the intended recipient's gaming terminal. The sender may then, for example, use a touch screen 34 to select the specific machine to receive the message. The recipient's gaming terminal's address will then be automatically entered as the electronic mail receiver 41. As described above, the sender may input the desired electronic mail message 43 and the electronic mail subject 42. The sender's e-mail address, or gaming terminal address is automatically entered automatically as the electronic mail sender 49. Once the message is received, the recipient may reply directly to the sender by composing a response and activating the reply icon as shown in FIG. 16. The recipient may locate the sender's location by using the same mapping function that is part of the network. The sender's gaming terminal is then highlighted showing its location relative to the recipient's gaming terminal.

Although for security purposes the use of a player-tracking card is highly recommended, it is also possible to use this embodiment in an anonymous mode by using only terminal identifiers to identify players exchanging messages. Although the flexibility of such a network is more limited, the player anonymity provides a more secure feeling to many people and can be effectively used to implement collaborative/competitive gaming that requires players to communicate with each other.

Still another method for addressing a message to a player is to assign a unique identifying number to each gaming terminal, or terminal identifier 62. This allows a message to be addressed to a specific terminal without the need to know the player's identity, nor the position of the gaming terminal. A gaming terminal list 61 may be presented to the player as depicted in FIG. 18. A message sender may select any active terminal to which to send his message. In this embodiment, the player basically follows the same steps as when a message is sent to a particular player's identifier, except that instead of the player's identifier, the sender inputs a gaming terminal identifier. Examples of gaming terminal identifiers may be, for example, 1234 casino. This embodiment again has the advantage of being able to allow anonymous e-mail capability between players. Further, the gaming terminal identifiers do not necessarily have to be static. In fact, the gaming terminal identifiers may be randomly changed to preserve anonymity and security on the network.

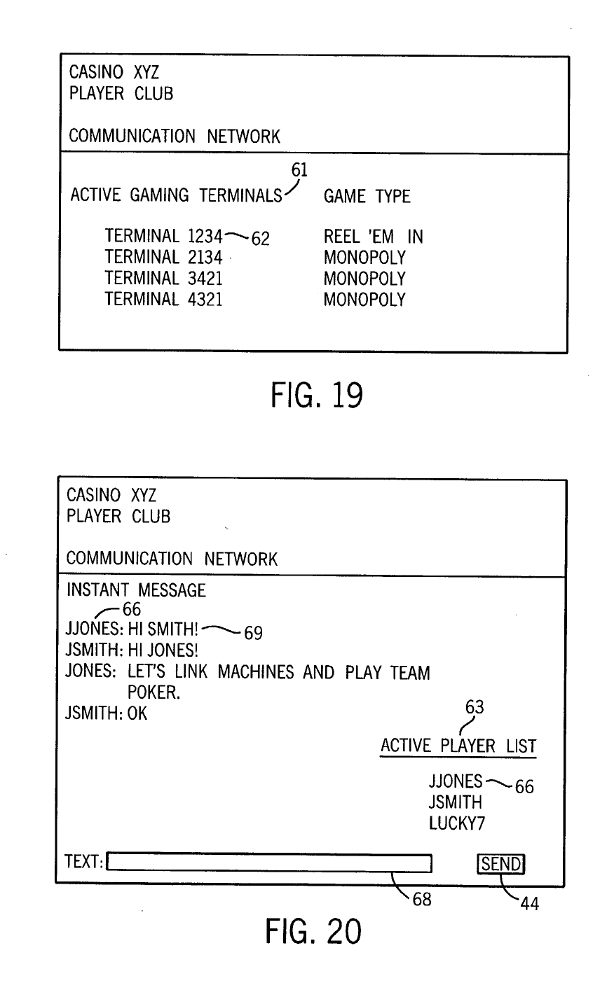

Finally, a player need not know the player's identity, the machine position on the gaming floor, or the gaming terminal's identifier to send a message. Instead, a listing of players on active gaming terminals may be displayed on the player's gaming terminal as depicted in FIG. 19 using random player identifiers 67. Temporary identifiers may be used for collaborative and competitive games where anonymity is particularly desired. Typically, these temporary identifiers are assigned by the central system on a random basis. For example, the central system may determine the player's designation, such as Player A or Player B, etc. Potentially these temporary identifiers may also be selected by the player. The selection process can be accomplished by simply scrolling through the temporary player identifier list and selecting a specific individual, or individuals, to contact. Selecting the random player identifier 67 directs messages to the player regardless of the gaming terminal the player is using.

In addition to its uses for allowing individual player communication, as well as competitive and collaborative gaming, the present invention may also be utilized to help provide services to players, as well as advertising. For example, a player may require a hand pay. Such a request may be sent automatically by the gaming terminal and received by an attendant at a terminal. The gaming terminal is identified in the text message (as well as identifying the player if they are using a player tracking card), and pinpointed by the machine's identifier on a casino map. The attendant uses this information to locate the player and make the hand pay. Similarly, a player desiring to order a drink, receive change, or other services may use the communication network to send a message to the player services terminal. To simplify the ease of making these requests, the player instead of being presented with a keyboard, may be presented with graphical user interfaces that allow the player to use the display touch screen to order the services he desires.

As part of the effort to provide player services, the casino may provide information to specific gaming terminals. This informational messaging may provide a player with information and advertising regarding casino services, as well as special offers and coupons that may be reproduced on gaming terminals with ticket dispensers. This advertising may be targeted toward a particular player at a gaming terminal, or broadcast to all gaming terminals. An example of this promotional adverting is shown in FIG. 16. Not only is the player notified of the event, he also has the capability to reserve a seat at the event by replying to the initial notice.

In addition to e-mail, players at the gaming terminals 10 may communicate with each other via instant messaging. Instant messaging differs from e-mail in the immediacy of the message exchange and also makes a continued exchange simpler than sending e-mail back and forth. Under most conditions, instant messaging is truly “instant.” Even during peak network usage periods, the delay is preferably no more than a second or two. It is possible for two players to have a real-time “conversation” by instant messaging each other back and forth. FIG. 20 depicts a sample image on a terminal's video display that enables a player to utilize instant messaging.

In order for instant messaging to work, both players must be logged into the network at the same time, and the intended recipient must be willing to accept instant messages. A player may establish preferences to accept messages from anyone, accept messages from only certain named players, reject messages from anyone, or reject messages from only certain named players. An attempt to send an instant message to a player who is not logged into the network, or who is not willing to accept instant messages, will result in notification that the transmission cannot be completed. If the preferences are set to accept instant messages, the terminal 10 alerts the recipient with a distinctive sound, a window that indicates that an instant message has arrived and allows the recipient to accept or reject it, or a window containing the incoming message. The instant messaging system may alert a player logged into the network at one terminal 10 whenever an individual on the player's selected list is logged onto the network.

Most exchanges are text-only; however, the instant messaging system may allow a player to send an attachment stored on the messaging computer 12b or the player's identification card. The messages may be created by the player or selected from a menu of predefined messages.

The instant messaging system essentially works in a very similar manner to the e-mail process described above. Instant messages may be addressed to individuals with permanent identifiers, to specific gaming terminal locations, to gaming terminals identifiers, or to players with temporary identifiers. Consequently as shown in FIG. 20, an active player list 63 is provided to show the sender all the potential players he may instant message. The active player list 63 may show permanent player identifiers, gaming terminal identifiers, or temporary player identifiers, provided that the player is logged onto the network and using a gaming terminal. The sender selects from the active player list 63 the intended recipient's identifier. The sender composes an instant message in the instant message text box 68, and activates the send instant message icon 44. The message appears on the recipient's, as well as the sender's display. The recipient may reply to the sender in the same manner. The player's identifier 66 appears adjacent to each message that the player sends.

Players at the gaming terminals 10 may also communicate with each other via text messaging. Text messaging is similar to instant messaging in that it involves sending short text messages (e.g., messages no longer than a few hundred characters) between the gaming terminals 10, but it also can involve sending short messages between a gaming terminal 10 and a mobile device such as a cellular phone, PDA, or pager.

Players at the gaming terminals 10 may also communicate with each other via group messaging. Group messaging is technically a channel, where a communication session takes place. Group messaging provides a venue for communities of players with a common interest to communicate in real time. If the group messaging is limited to two players, it is synonymous with instant messaging.

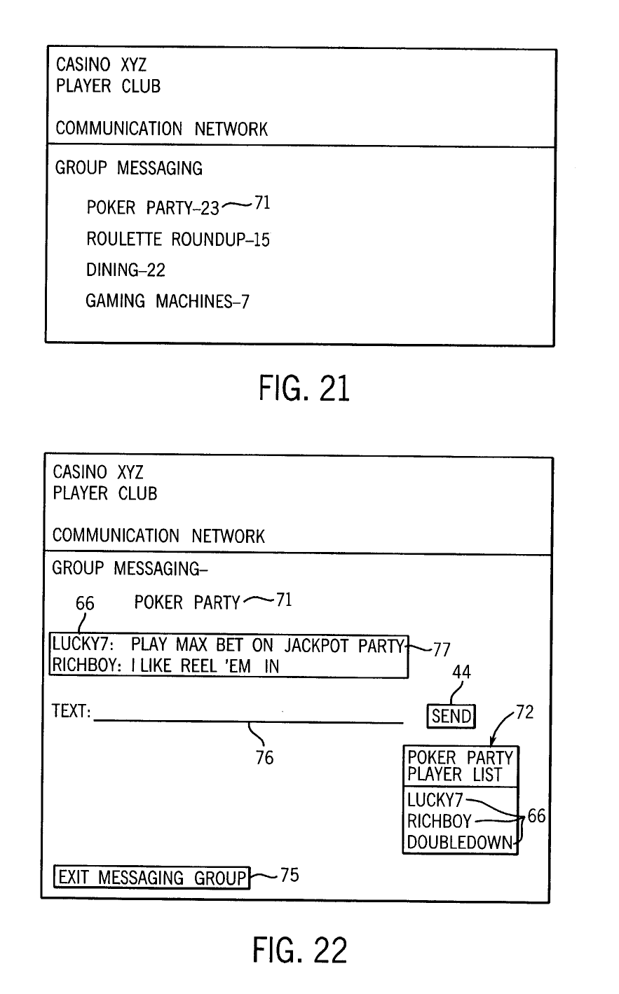

Message centers, in comparison, allow players to post messages but do not have the capacity for interactive messaging. Chat room users enter the chat room of their choice. Inside the chat room there may be a list of players currently in the chat room, or chat room list 72. These players may be alerted that another player has entered the chat room. To chat, a player types a message into a text box. The message is almost immediately visible in a larger communal message area and other players may respond. FIG. 21 depicts a sample image on a terminal's video display that enables a player to utilize chat rooms.

To communicate to players in a chat room, a chat room may be selected from a chat room list, which is shown in FIG. 21. As election of a specific group message center 71 causes all the players in that center to be listed, providing the potential message sender a list of all the players that will view the message. The player may elect to join the chat room by activating the join group icon 74. This places the player identifier 66 into a specific group message center 71. The player's identifier may be his permanent identifier 64, temporary identifier 65, the gaming terminal identifier 62, a random identifier 67 or the gaming terminal location (which is converted into a gaming terminal identifier). If the player wishes to send a message to those in the chat room he enters the text as a group message 76, which is immediately sent to all players in the chat room after the send message icon is activated 44. The sender's player identifier 66 is placed next to the message to allow players to be distinguished from other players in the chat room. If the player decides to leave the chat room, he merely activates the exit message group icon 75, which immediately removes the player's identifier 66 from the group message player identifier list 72.

This embodiment presents significant application for collaborative and competitive gaming, as well as for specific applications in tournament play. In a combination competitive/collaborative gaming environment teams may be formed to compete against each other. Team members may be allowed to collaborate to aid the team in winning the competition. A chat room is formed that may consist of all players from team A and a second chat room is formed for all players of team B. Players on a particular team may message all players on their team to develop a play consensus or instantly provide play information to all players on a team. In competitive/collaborative gaming environment, anonymous communication between teammates allows players to develop game play strategies and compete more effectively against other players.

This system of directing communication to a randomly identified player provides a highly secure gaming environment by maintaining player anonymity. It also allows gaming terminals to be randomly linked in a secretive manner that secures the game's integrity against players that might seek to affect game outcome by playing both sides of a competitive game. The chat room communication works in much the same way as instant messaging described above, particularly with respect to the almost instantaneous mode of communication. As a result, the same competitive/collaborative type gaming assistance that the chat room can provide to a team of players would be similar to the type of assistance that instant messaging can provide to a team of two players.

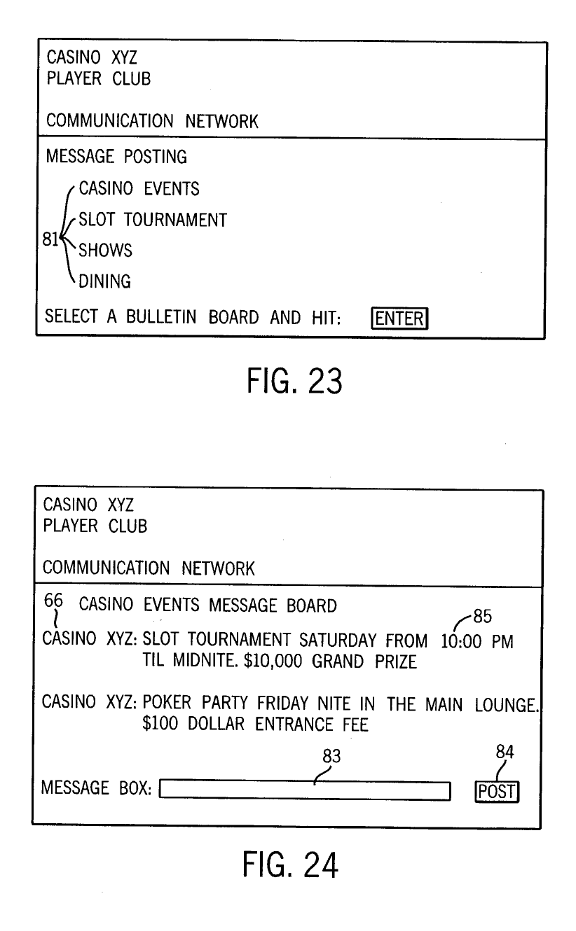

Players at the gaming terminals 10 may communicate with each other via an electronic message center. An electronic message center allows players to review messages left by other players and post their own messages as depicted in FIG. 23. The message center may provide a variety of electronic newsgroups (forums) or bulletin boards in which participants with common interests can exchange open messages. The interests may, for example, relate to both gaming and non-gaming topics. Gaming topics may, for example, include electronic wagering games, table games, sportsbook, restaurants, amenities, attractions, promotions, etc. To view messages posted to a newsgroup and post messages to a newsgroup, each terminal 10 may run a client application that connects the terminal 10 to a news server on the messaging computer 12b.

A player may select the bulletin board icon 54 depicted in FIG. 11 to review the message posting boards 81 that are available for inspection. A player may then select a specific bulletin board from the list. Typically, this is easily done with a touch screen, or in lieu of a touch screen, a typical computer device, such as a mouse, trackball, or scroll key, may be used to indicate a selection. An input key, such as an enter key or select key may be used to allow a player to make a specific message board selection. This selection opens the message board to allow the player to view it contents as shown in FIG. 24. A player may then post a message by typing text into the message posting board 83. When satisfied with their message, the player may then post the message by activating the send message icon 44. The message, along with the player's identifier 66, may then be posted on the message board.

Players at the gaming terminals 10 may also communicate with each other via network telephony. Network telephony enables players at the gaming terminals 10 to use the network as the transmission medium for telephone calls. The terminals 10 may be outfitted with off-the-shelf network telephony applications. If the network uses the Internet Protocol (IP), network telephony may be called voice over IP, i.e., voice delivered using the Internet Protocol. Voice over IP is a set of facilities for managing the delivery of voice information using the Internet Protocol. In general, this means sending voice information in digital form in discrete packets rather than in the traditional circuit-committed protocols of the public switched telephone network (PSTN). Using the network, calls travel as packets of data on shared lines. In addition to the Internet Protocol, voice over IP uses the real-time protocol (RTP) to help ensure that packets get delivered in a timely way.

To utilize voice over IP in the gaming terminal environment, each gaming terminal must be equipped with an audio jack to allow headphones and a headset to be plugged into the gaming terminal. Alternatively, a standard telephone handset could be attached to the gaming terminal. Still another method for allowing voice communication is simply to use the gaming terminal's speakers 27 and a built in microphone 25 as depicted in FIG. 7.

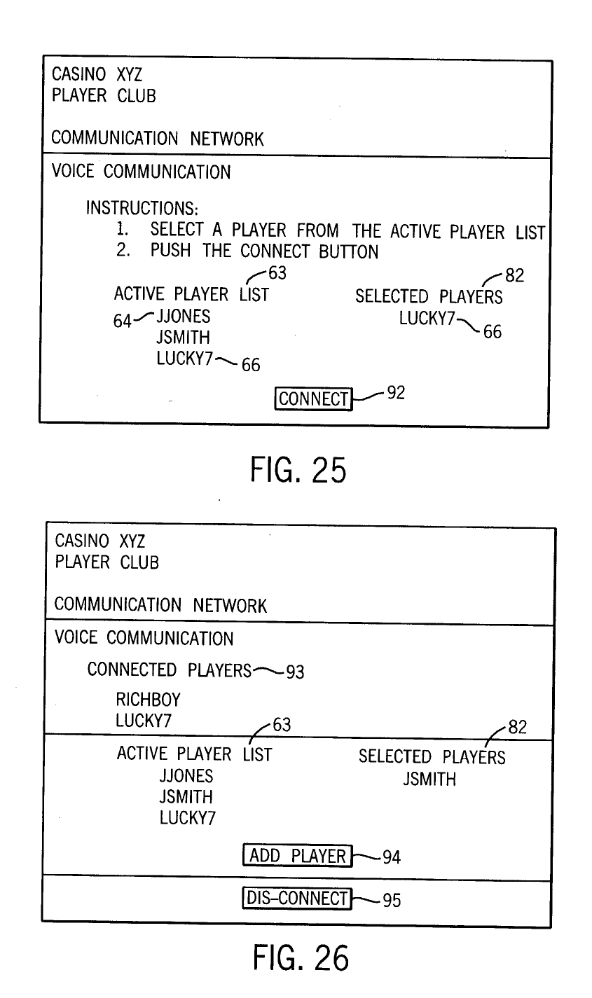

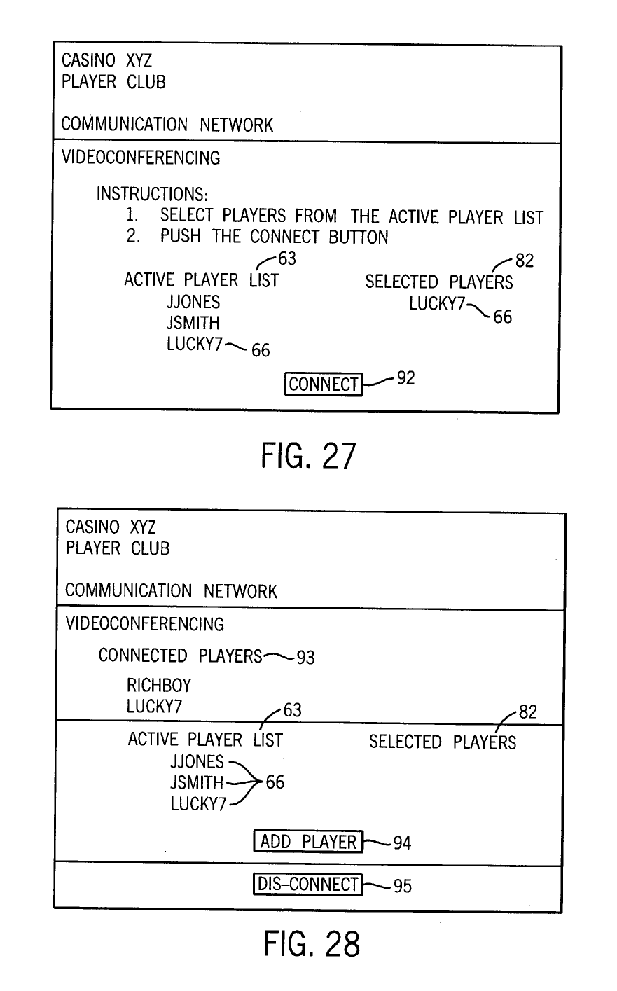

To operate the system a player must identify the player he desires to speak with as shown in FIG. 25 from the active player list 63. In a process similar to e-mail discussed above, a recipient may be identified by their permanent identifier 64, by the location of the gaming terminal, by the gaming terminal identifier 62, by a random player identifier 67 or by a temporary identifier 65 associated with a specific individual player. A player merely selects the players from the active player list 63 that he wishes to communicate. The selected players identifiers appear on a selected player list 82. The selected player list identifies to all the players those that are participating in the communication. Once all the players have been selected, the player activates the connection icon 92 to connect the players to a common communication line. As the players connect, a visual indication is given to each connected player identifier, and added to the connected player list 93. A player may also be entered into the communication at a later time using the selected players list 91 in conjunction with the connect player icon 92. A player that hits the disconnect player icon 95 is removed from the connected players list 93 and from the communication.

The gaming terminal then signals the recipient that he has an incoming voice message that the receiving player may accept by using a head set, telephone handset, or simply using the gaming terminal's built-in speakers 27 and microphone 25 to communicate with the calling party. When the communication is over either player may hit the disconnect icon 95 to terminate the audio connection.

In addition to communication between players for use in competitive and collaborative gaming, as well as any other messaging needs, the voice over IP has additional advantages that provide a superior gaming environment for players. Among these is the ability to use the voice over IP to provide a broadcast distribution of audio data to select players. This broadcast distribution may be set from the central system and may contain content related to casino events. It can also be used among a community of players that are engaged in competitive/collaborative game play. The central system can provide information and statistics to these players in real time that may arise in the play of the game, provide critical gaming information, sound effects to accompany the game, or any other information related to game play. This network is extremely flexible as it can selectively address those players who are participating in the game, as well as any subset of these individuals.

Players at the gaming terminals 10 may communicate with each other via conferencing. Conferencing may be limited to audio or also include video, and may use multicasting. Videoconferencing involves conducting a conference between two or more players at different gaming terminals 10 by using the network to transmit audio and video data. For example, a point-to-point (two-person) videoconferencing system works much like a video telephone. Each player has a video camera 29, microphone 25, and speakers 27 mounted on his or her terminal 10 as shown in FIG. 7. As the two players speak to one another, their voices are carried over the network and delivered to the other's speakers 27, and whatever images appear in front of the video camera 29 appear in a window on the video display of the other player's terminal 10. Multipoint videoconferencing allows three or more players to sit in a virtual conference room and communicate as if they are sitting right next to each other. The videoconferencing system may allow players in a conference to do more than just talk. For example, once a conference is established, the players can share applications (including wagering games played at their respective terminals) and mark up a common whiteboard. The players are further able to use picture-in-a-picture technology to share images and sounds with other selected players to which they are teleconferenced. This feature can be used as a tool to assist in game playing between competing teams of players. For example, the picture-in-a-picture feature can be used to transmit each team players card hand to the other team player, allowing players to jointly strategize their next move.

A video-conferencing communication is set up in the same manner as the voice communication system described above. For example, players may be invited to participate in a shared game experience with notification appearing on their video screen. Each participating player will see every other participating player on his or her gaming terminal's video display. Players may use an audio jack and a headset to hear participating players. Player's may use this communication mode to play games, offer advice, or strategize on the best means to win the game. When the game is over, the players may be automatically logged off the network, or a player may decide to quit the game, and withdraw from the teleconference by manually logging off the network, or simply removing their player tracking card.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for allowing players at gaming terminals to communicate with each other, the method comprising:
conducting wagering games on the gaming terminals;
generating a personal message at one of the gaming terminals in response to input of a player at the one of the gaming terminals; and
presenting the personal message at at least one other of the gaming terminals.

2. The method of claim 1, wherein the personal message includes content selected from a group consisting of text, audio, and video.

3. The method of claim 1, wherein the personal message is generated via a messaging technology selected from a group consisting of electronic mail, instant messaging, a chat room, network telephony, conferencing, and an electronic message center.

4. The method of claim 1, wherein the gaming terminals are linked over a network, the personal message being transmitted from the one of the gaming terminals to the at least one other of the gaming terminals via the network.

5. The method of claim 4, wherein the network is selected from a group consisting of a wired network and a wireless network.

6. The method of claim 4, wherein the network uses broadband transmission.

7. The method of claim 1, further including transmitting the personal message from the one of the gaming terminals to the at least one other of the gaming terminals.

8. The method of claim 7,
wherein the at least one other of the gaming terminals includes a plurality of gaming terminals; and
wherein the transmitting step broadcasts the personal message from the one of the gaming terminals to the plurality of gaming terminals.

9. The method of claim 1, wherein the personal message is created by the player.

10. The method of claim 9, wherein the one of the gaming terminals includes a keyboard, the personal message being typed by the player with the keyboard.

11. The method of claim 1, wherein the personal message is selected by the player from a menu of predefined messages.

12. The method of claim 1, wherein the personal message includes the player's voice.

13. The method of claim 12, wherein the generating step includes capturing the player's voice with a microphone at the one of the gaming terminals.

14. The method of claim 1, wherein the personal message includes the player's image.

15. The method of claim 14, wherein the generating step includes capturing the player's image with a video camera at the one of the gaming terminals.

16. The method of claim 1, further including receiving a selection from the player at the one of the gaming terminals of the at least one other of the gaming terminals at which the personal message is to be presented.

17. The method of claim 1, further including:
presenting the player at the one of the gaming terminals with a list of players playing at the gaming terminals; and
receiving a selection from the player at the one of the gaming terminals of at least one player from the list; and
wherein the presenting step presents the personal message at the at least one other of the gaming terminals associated with the at least one selected player.

18. The method of claim 17,
wherein the gaming terminals are linked over a network; and
wherein the list of players playing at the gaming terminals includes players logged into the network.

19. The method of claim 18,
wherein the player at the one of the gaming terminals is logged into the network; and
wherein the list of players playing at the gaming terminals includes players in a personal list associated with the player at the one of the gaming terminals.

20. The method of claim 1, wherein the gaming terminals are linked over a network, and further including:
permitting the player at the one of the gaming terminals to log into the network;
presenting the player at the one of the gaming terminals with a list of players logged into the network and included in a personal list associated with the logged-in player at the one of the gaming terminals; and
receiving a selection from the player at the one of the gaming terminals of at least one player from the list; and
wherein the presenting step presents the personal message to the at least one other of the gaming terminals associated with the at least one selected player.

21. The method of claim 1, wherein the gaming terminals are linked over a network, the player at the one of the gaming terminals being logged into the network, and further including:
presenting the player at the one of the gaming terminals with at least a partial list of players logged into the network via the gaming terminals; and
receiving a selection from the player at the one of the gaming terminals of at least one player from the list; and
wherein the presenting step presents the personal message at the at least one other of the gaming terminals associated with the at least one selected player.

22. The method of claim 1, wherein the gaming terminals are linked to a central system over a network, the central system managing a plurality of personal messages transmitted over the network.

23. The method of claim 22, wherein the plurality of personal messages include electronic mail, the central system moving and storing the electronic mail over the network.

24. The method of claim 23, wherein the central system manages mailing lists.

25. The method of claim 22, wherein the plurality of personal messages include real-time messages, the central system enabling players at the gaming terminals to exchange the real-time messages in real-time via a messaging technology selected from a group consisting of instant messaging, text messaging, chat rooms, network telephony, and conferencing.

26. The method of claim 22, wherein the plurality of personal messages include posted messages, the central system enabling players to exchange the posted messages via a message center where the posted messages can be posted and viewed.

27. The method of claim 1, wherein the gaming terminals are linked over a network, the player at the one of the gaming terminals and a player at the at least one other of the gaming terminals being logged into the network.

28. A system for allowing players at gaming terminals to communicate with each other, the system comprising:
the gaming terminals for conducting wagering games;
at least one of the gaming terminals for generating a personal message in response to input of a player at the one of the gaming terminals; and
at least one other of the gaming terminals for presenting the personal message.

29. The system of claim 28, wherein the personal message includes content selected from a group consisting of text, audio, and video.

30. The system of claim 28, wherein the personal message is generated via, a messaging technology selected from a group consisting of electronic mail, instant messaging, a chat room, network telephony, conferencing, and an electronic message center.

31. The system of claim 28, wherein the gaming terminals are linked over a network, the personal message being transmitted from the one of the gaming terminals to the at least one other of the gaming terminals via the network.

32. The system of claim 31, wherein the network is selected from a group consisting of a wired network and a wireless network.

33. The system of claim 31, wherein the network uses broadband transmission.

34. The system of claim 28, wherein the personal message is transmitted from the one of the gaming terminals to the at least one other of the gaming terminals.

35. The system of claim 34,
wherein the at least one other of the gaming terminals includes a plurality of gaming terminals; and
wherein the personal message is broadcast from the one of the gaming terminals to the plurality of gaming terminals.

36. The system of claim 28, wherein the personal message is created by the player.

37. The system of claim 36, wherein the one of the gaming terminals includes a keyboard, the personal message being typed by the player with the keyboard.

38. The system of claim 28, wherein the personal message is selected by the player from a menu of predefined messages.

39. The system of claim 28, wherein the personal message includes the player's voice.

40. The system of claim 39, wherein the one of the gaming terminals includes a microphone for capturing the player's voice.

41. The system of claim 28, wherein the personal message includes the player's image.

42. The system of claim 41, wherein the one of the gaming terminals includes a video camera for capturing the player's image.

43. The system of claim 28, wherein the one of the gaming terminals includes a user interface for receiving a selection from the player at the one of the gaming terminals of the at least one other of the gaming terminals at which the personal message is to be presented.

44. The system of claim 28,
wherein the one of the gaming terminals includes a display for presenting the player with a list of players playing at the gaming terminals;
wherein the one of the gaming terminals includes a user interface for receiving a selection from the player of at least one player from the list; and
wherein the personal message is presented at the at least one other of the gaming terminals associated with the at least one selected player.

45. The system of claim 44,
wherein the gaming terminals are linked over a network; and
wherein the list of players playing at the gaming terminals includes players logged into the network.

46. The system of claim 45,
wherein the player at the one of the gaming terminals is logged into the network; and
wherein the list of players playing at the gaming terminals includes players in a personal list associated with the player at the one of the gaming terminals.

47. The system of claim 28,
wherein the gaming terminals are linked over a network;
wherein the one of the gaming terminals includes a user interface for permitting the player at the one of the gaming terminals to log into the network;
wherein the one of the gaming terminals includes a display for presenting the player at the one of the gaming terminals with a list of players logged into the network and included in a personal list associated with the logged-in player at the one of the gaming terminals;
wherein the user interface receives a selection from the player at the one of the gaming terminals of at least one player from the list; and
wherein the personal message is presented to the at least one other of the gaming terminals associated with the at least one selected player.

48. The system of claim 28,
wherein the gaming terminals are linked over a network, the player at the one of the gaming terminals being logged into the network;
wherein the one of the gaming terminals includes a display for presenting the player at the one of the gaming terminals with at least a partial list of players logged into the network via the gaming terminals;
wherein the one of the gaming terminals includes a user interface for receiving a selection from the player at the one of the gaming terminals of at least one player from the list; and
wherein the personal message is presented at the at least one other of the gaming terminals associated with the at least one selected player.

49. The system of claim 28, wherein the gaming terminals are linked to a central system over a network, the central system managing a plurality of personal messages transmitted over the network.

50. The system of claim 49, wherein the plurality of personal messages include electronic mail, the central system moving and storing the electronic mail over the network.

51. The system of claim 50, wherein the central system manages mailing lists.

52. The system of claim 49, wherein the plurality of personal messages include real-time messages, the central system enabling players at the gaming terminals to exchange the real-time messages in real-time via a messaging technology selected from a group consisting of instant messaging, text messaging, chat rooms, network telephony, and conferencing.

53. The system of claim 49, wherein the plurality of personal messages include posted messages, the central system enabling players to exchange the posted messages via a message center where the posted messages can be posted and viewed.

54. The system of claim 28, wherein the gaming terminals are linked over a network, the player at the one of the gaming terminals and a player at the at least one other of the gaming terminals being logged into the network.

55. A method for allowing a player at a gaming terminal to communicate a message to a remote terminal, the method comprising:
generating a personal message at a gaming terminal in response to the input of a player at the gaming terminal;
selecting a remote terminal to which the personal message is to be delivered;
transmitting the personal message to a central system over a local area network, the central system in communication with a global computing network; and
transmitting the personal message from the central system to the remote terminal over the global computing network.

56. A method for allowing players at gaming terminals to communicate with each other, the method comprising:
conducting a wagering game on the gaming terminals;
selecting a gaming terminal to deliver an image of at least a portion of the wagering game display;
transmitting the image to the selected gaming terminal; and
displaying the image on the display of the selected gaming terminal.
